(19) United States
(12) Patent Application Publication
(10) Pub. No.: US 2025/0234360 A1
(43) Pub. Date: Jul. 17, 2025

(54) MESSAGE TRANSMISSION METHOD, APPARATUS, DEVICE, AND STORAGE MEDIUM

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 18/876,371

(22) PCT Filed: Jun. 21, 2022
(86) PCT No.: PCT/CN2022/100246

§ 371 Date: Dec. 18, 2024

(51) Int. Cl. H04W 72/25; H04W 76/38

(52) U.S. Cl. CPC H04W 72/25; H04W 76/38

(57) ABSTRACT

A message transmission method is performed by a remote user equipment (UE) and includes: sending a first message to a relay UE; entering an active state to monitor a sidelink (SL) between the remote UE and the relay UE; and exiting the active state, where the remote UE receives a second message, and the second message is a response message to the first message.

### CROSS REFERENCE TO RELATED APPLICATION

This application is the U.S. national stage of International Application No. PCT/CN2022/100246, filed on Jun. 21, 2022, which is incorporated by reference herein in its entireties for all purposes.

### TECHNICAL FIELD

This disclosure relates to the field of communication technology, and in particular to message transmission methods/apparatuses/devices and storage medium.

### BACKGROUND

In the communication system, direct communication between user equipment (UE) is achieved by introducing the sidelink (SL) communication manner. Moreover, in order to save the power consumption of SL UE, the discontinuous reception (DRX) of SL is introduced. In other words, the receiving UE only monitors the second-stage sidelink control information (SCI) on the logical channel in the active state. Furthermore, the UE may not directly communicate with the base station, but may communicate with the base station through the relay of another UE. Herein, the UE that is not connected to the base station is called the remote UE, and the UE that provides the relay function is called the relay UE. In addition, the remote UE and the relay UE can communicate through SL unicast.

In related art, the remote UE in the idle state can send a radio resource control (RRC) establishment request message to the relay UE, so that the relay UE forwards the RRC establishment request message to the base station, and forwards an RRC establishment message sent by the base station to the remote UB, thereby completing the connection establishment procedure. Moreover, the remote UE in the inactive state can send an RRC resume request message to the relay UE, so that the relay UE forwards the RRC resume request message to the base station, and forward an RRC resume message sent by the base station to the remote UE, thereby completing the connection resume procedure. Furthermore, when connection failure occurs at the remote UE, the remote UE can send an RRC reestablishment request message to the relay UE, so that the relay UE forwards the RRC reestablishment request message to the base station, and forwards an RRC reestablishment message sent by the base station to the remote UE, thereby completing the connection reestablishment procedure. In addition, the remote UE can also send a system information request message to the relay UE, and receive system information sent by the relay UE.

However, in related art, after the remote UE sends the RRC establishment request/resume request/reestablishment request/system information request message to the relay UE, the remote UE may enter the SL DRX sleep state, and thus be unable to receive the RRC establishment message/resume message/reestablishment message/system information forwarded by the relay UE, thereby causing failure of connection establishment/connection resume/connection reestablishment, or causing transmission of system information to be delayed, and further affecting the stability of SL communication.

### SUMMARY

The message transmission methods/apparatuses/devices and storage medium proposed in this disclosure are directed to solve the technical problem that the solutions in the related art affect the stability of SL communication.

In a first aspect, embodiments of this disclosure provide a message transmission method, which is performed by a remote UE and includes:
sending a first message to a relay UE;
the remote UE entering an active state to monitor an SL between the remote UE and the relay UE; and
the remote UE stopping the active state in response to receiving a second message, wherein the second message is a response message to the first message.

In this disclosure, the active state will be stopped only after the remote UE receives the response message (i.e., the second message) of the relay UE to the first message with respect to the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

In an embodiment, the remote UE entering the active state includes:
the remote UE entering the active state immediately after sending the first message to the relay UE.

In an embodiment, the remote CE entering the active state includes:
starting a timer after sending the first message to the relay UE; and
the remote UE entering the active state in response to expiration of the timer.

In an embodiment, the method further includes at least one of the following:
receiving a timing duration configured by a network device for the timer;
receiving a timing duration configured by the relay UE for the timer.

In an embodiment, a retention time of the UE active state includes any one of the following:
a running time of T300 timer;
a running time of T301 timer;
a running time of T319 timer;
a running time of T319a timer.

In an embodiment, the first message includes at least one of the following:
a message in a specific bearer;
a message in a specific logical channel;
a first radio resource control (RRC) message;
a first RRC message carrying a specific request;
a first SL RRC message;
a first SL RRC message carrying a specific request.

In an embodiment, the second message includes at least one of the following:
a message in a specific bearer;
a message in a specific logical channel;
a second RRC message;
a second RRC message carrying a specific configuration;
a second SL RRC message;
a second SL RRC message carrying a specific configuration.

In an embodiment, the specific bearer includes at least one of the following:
signaling radio bearer (SRB) 0;
SRB1;
SRB2.

In an embodiment, the first RRC message includes at least one of.
an RRC establishment request message;
an RRC resume request message;
an RRC reestablishment request message;
a system information request message.

In an embodiment, the first SL RRC message includes a remote UE information message (RemoteUJEInformationSidelink).

In an embodiment, the specific request includes a request for specific system information.

In an embodiment, the second RRC message includes at least one of the following:
an RRC establishment message;
an RRC resume message;
an RRC reestablishment message;
an RRC reconfiguration message.

In an embodiment, the second SL RRC message includes a Un message transfer message (UuMessage TransferSidelink).

In an embodiment, the specific configuration includes specific system information.

In an embodiment, the specific system information is specified by a protocol.

In a second aspect, embodiments of this disclosure provide a message transmission method, which is performed by a relay UE and includes:
receiving a first message sent by a remote UE;
forwarding the first message to a base station;
receiving a second message sent by the base station, wherein the second message is a response message to the first message; and
forwarding the second message to the relay UE.

In an embodiment, the method further includes:
configuring a timing duration for the remote UE.

In a third aspect, embodiments of this disclosure provide a message transmission method, which is performed by a base station and includes:
receiving a first message sent by a relay UE; and
sending a second message to the relay UE, wherein the second message is a response message to the first message.

In an embodiment, the method further includes:
configuring a timing duration for the remote UE.

In a fourth aspect, embodiments of this disclosure provide a communication device, which is configured in a remote UE and includes:
a transceiving module, configured to send a first message to a relay UE; and
a processing module, configured to monitor, in an active state of the remote UE, an SL between the remote UE and the relay UE;
wherein the processing module is further configured to stop the active state of the remote UE in response to receiving a second message, wherein the second message is a response message to the first message.

In a fifth aspect, embodiments of this disclosure provide a communication device, which is configured in a relay UE and includes:
a transceiving module, configured to receive a first message sent by a remote UE;
   wherein
the transceiving module is further configured to forward the first message to a base station;
the transceiving module is further configured to receive a second message sent by the base station, wherein the second message is a response message to the first message: and
the transceiving module is further configured to forward the second message to the relay UE.

In a sixth aspect, embodiments of this disclosure provide a communication device, which is configured in a base station and includes:
receiving a first message sent by a relay UE;
sending a second message to the relay UE, wherein the second message is a response message to the first message.

In a seventh aspect, embodiments of this disclosure provide a communication device. The communication device includes a processor which, upon calling a computer program in a memory, is configured to implement the method described in the first aspect.

In an eighth aspect, embodiments of this disclosure provide a communication device. The communication device includes a processor which, upon calling a computer program in a memory, is configured to implement the method described in the second aspect.

In a ninth aspect, embodiments of this disclosure provide a communication device. The communication device includes a processor which, upon calling a computer program in a memory, is configured to implement the method described in the third aspect.

In a tenth aspect, embodiments of this disclosure provide a communication device. The communication device includes a processor and a memory, wherein a computer program is stored in the memory, and the processor is configured to execute the computer program stored in the memory, thereby causing the communication device to implement the method described in the first aspect.

In an eleventh aspect, embodiments of this disclosure provide a communication device. The communication device includes a processor and a memory, wherein a computer program is stored in the memory, and the processor is configured to execute the computer program stored in the memory, thereby causing the communication device to implement the method described in the second aspect.

In a twelfth aspect, embodiments of this disclosure provide a communication device. The communication device includes a processor and a memory, wherein a computer program is stored in the memory, and the processor is configured to execute the computer program stored in the memory, thereby causing the communication device to implement the method described in the third aspect.

In a thirteenth aspect, embodiments of this disclosure provide a communication device. The device includes a processor and an interface circuit, where the interface circuit is configured to receive code instructions and transmit them to the processor, and the processor is configured to run the code instructions, thereby causing the device to implement the method described in the first aspect.

In a fourteenth aspect, embodiments of this disclosure provide a communication device. The device includes a processor and an interface circuit, where the interface circuit is configured to receive code instructions and transmit them to the processor, and the processor is configured to run the code instructions, thereby causing the device to implement the method described in the second aspect.

In a fifteenth aspect, embodiments of this disclosure provide a communication device. The device includes a processor and an interface circuit, where the interface circuit is configured to receive code instructions and transmit them to the processor, and the processor is configured to run the code instructions, thereby causing the device to implement the method described in the third aspect.

In a sixteenth aspect, embodiments of this disclosure provide a communication system, which includes the communication devices described in the fourth aspect to the sixth aspect, or includes the communication devices described in the seventh aspect to the ninth aspect, or includes the communication devices described in the tenth aspect to the twelfth aspect, or includes the communication devices described in the thirteenth aspect to the fifteenth aspect.

In a seventeenth aspect, embodiments of this disclosure provide a computer readable storage medium for storing instructions used by the above-mentioned network device. When the instructions are executed, the terminal device is caused to implement the method according to any one of the first to third aspects as described above.

In an eighteenth aspect, this disclosure further provides a computer program product including a computer program, which, when run on a computer, causes the computer to implement the method according to any one of the first to third aspects as described above.

In a nineteenth aspect, this disclosure provides a chip system that includes at least one processor and an interface for supporting a network device to implement the functions involved in the method described in any one of the first to third aspects, for example, to process at least one of data and information involved in the above method. In a possible implementation, the chip system further includes a memory, which is configured to store necessary computer program(s) and data of the source secondary node(s). The chip system may be composed of chips, or may include chips and other discrete devices.

In a twentieth aspect, this disclosure provides a computer program that, when run on a computer, causes the computer to implement the method according to any one of the first to third aspects as described above.

### BRIEF DESCRIPTION OF THE DRAWINGS

The above and/or additional aspects and advantages of this disclosure will become apparent and readily understood from the following description of the embodiments in conjunction with the accompanying drawings, in which:

FIG. 1 is a schematic architectural diagram of a communication system according to an embodiment of this disclosure;

FIG. 2 is a schematic flowchart of a message transmission method according to another embodiment of this disclosure;

FIG. 3 is a schematic flowchart of a message transmission method according to yet another embodiment of this disclosure;

FIG. 4 is a schematic flowchart of a message transmission method according to yet another embodiment of this disclosure;

FIG. 5 is a schematic flowchart of a message transmission method according to another embodiment of this disclosure;

FIG. 6 is a schematic flowchart of a message transmission method according to yet another embodiment of this disclosure;

FIG. 7 is a schematic flowchart of a message transmission method according to yet another embodiment of this disclosure;

FIG. 8 is a schematic flowchart of a message transmission method according to an embodiment of this disclosure;

FIG. 9 is a schematic structural diagram of a communication device according to an embodiment of this disclosure:

FIG. 10 is a schematic structural diagram of a communication device according to another embodiment of this disclosure;

FIG. 11 is a schematic structural diagram of a communication device according to another embodiment of this disclosure;

FIG. 12 is a block diagram of a user equipment according to an embodiment of this disclosure: and

FIG. 13 is a block diagram of a network side device according to an embodiment of this disclosure.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with this application. Rather, they are merely examples of apparatus and methods consistent with aspects of the application as detailed in the appended claims.

The terminology used in this disclosure is for the purpose of describing particular embodiments only and is not intended to limit the disclosure. As used in this disclosure and the appended claims, the singular forms “a/an” and “the” are intended to include the plural forms as well, unless the context clearly dictates otherwise. It will also be understood that the term “and/or” as used herein refers to and includes any and all possible combinations of one or more of the associated listed items.

It should be understood that although the terms first, second, third, etc. may be used in this disclosure to describe various information, the information should not be limited to these terms. These terms are only used to distinguish information of the same type from each other. For example, without departing from the scope of the present disclosure, the first information may also be called second information, and similarly, the second information may also be called first information. Depending on the context, the words “if” and “in case” as used herein may be interpreted as “when” or “while” or “in response to determining.”

Embodiments of this disclosure are described in detail below, examples of which are illustrated in the accompanying drawings, wherein the same or similar reference numerals refer to the same or similar elements throughout. The embodiments described below with reference to the accompanying drawings are exemplary and intended to explain this disclosure without being construed as limitations of this disclosure.

To facilitate understanding, the terminologies involved in this application are first introduced.
1. 5th generation mobile networks (5G)

5G is a new generation of broadband mobile communication technology with characteristics of high speed, low latency and large connection. It is the network infrastructure that realizes the interconnection of humans, machines and things.
2. Sidelink (SL)

It is a link for direct communication between UEs.
3. Remote UE

It refers to UE that does not communicate directly with the base station but communicates with the base station through other UEs.
4. Relay UE

It refers to UE used to implement relay communications between other UEs and the base station.

In order to better understand a message transmission method disclosed in the embodiments of this disclosure, the communication system to which the embodiments of this disclosure are applicable is first described below.

Referring to FIG. 1, which is a schematic architectural diagram of a communication system according to an embodiment of this disclosure. The communication system may include but is not limited to a network device, a remote UE and a relay UE. The number and form of devices shown in FIG. 1 are only for examples without constituting a limitation on the embodiments of this disclosure. In practical applications, it may include two or more network devices and two or more UEs. The communication system shown in FIG. 1 includes one network device 11, one remote UE 12, and one relay UE 13 as an example.

It should be noted that the technical solutions according to the embodiments of this disclosure can be applied to various communication systems, for example, long term evolution (LTE) system, SG mobile communication system, 5G new radio (NR) system, or other future new mobile communication systems.

The network device 11 in the embodiment of this disclosure is an entity on the network side that is configured to transmit or receive signals. For example, the network device 11 may be an evolved NodeB (eNB), a transmission reception point (TRP), a next generation NodeB (gNB) in the NR system, or other base stations in future mobile communication systems, or base stations or access nodes in wireless fidelity (WiFi) systems, or the like. The embodiments of this disclosure do not limit the specific technologies and specific device forms used by network device. The network device according to the embodiments of this disclosure may be composed of a centralized unit (CU) and a distributed unit (DU). The CU may also be called a control unit. When CU-DU structure is used, the protocol layers of network devices, such as base stations, can be separated, with some protocol layer functions standing centralized control on the CU, part or all of remaining protocol layer functions being distributed in the DU, and the CU centrally controlling the DU.

The remote UE 12 and the relay UE 13 in the embodiments of this disclosure may be entities on the user side for receiving or transmitting signals, such as a mobile phone. Terminal device can also be called terminal, UE, mobile station (MS), mobile terminal (MT), or the like. The terminal device can be a car with communication functions, a smart car, a mobile phone, a wearable device, a tablet computer (Pad), a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. The embodiments of this disclosure do not limit the specific technology and specific device form used by the terminal device.

It can be understood that the communication system described in the embodiments of this disclosure is to more clearly illustrate the technical solutions of the embodiments of this disclosure, and does not constitute a limitation on the technical solutions according to the embodiments of this disclosure. As those of ordinary skill in the art will know, with the evolution of system architecture and the emergence of new service scenarios, the technical solutions according to the embodiments of this disclosure are also applicable to similar technical problems.

The message transmission methods/apparatuses/devices and storage medium according to the embodiments of this disclosure will be described in detail below with reference to the accompanying drawings.

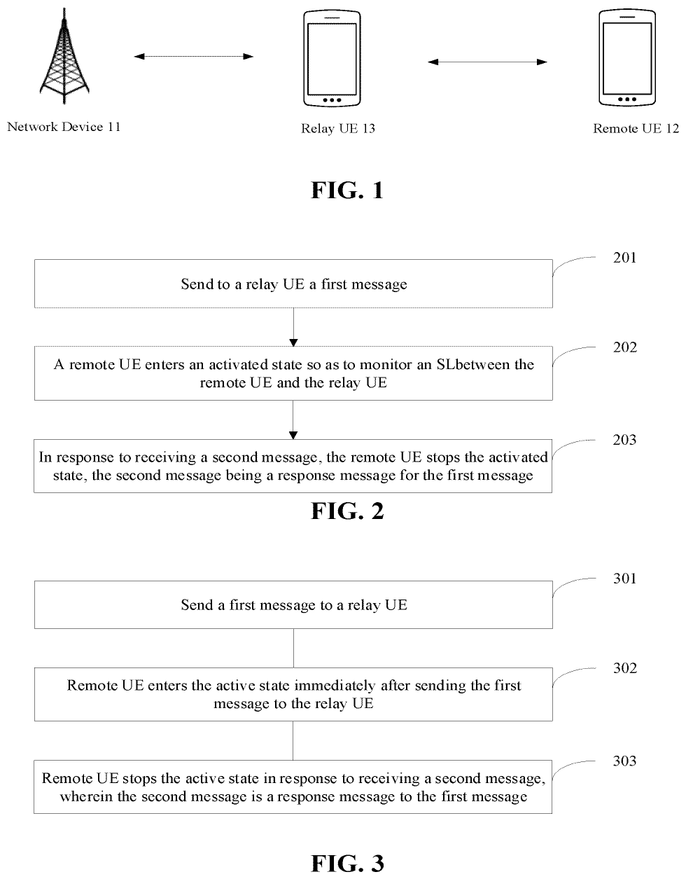

FIG. 2 is a schematic flowchart of a message transmission method according to an embodiment of this disclosure. The method is performed by a remote UE. As shown in FIG. 2, the message transmission method may include the following steps.

In step 201, a first message is sent to a relay UE.

In an embodiment of this disclosure, the first message may include at least one of the following:
a message in a specific bearer;
a message in a specific logical channel;
a first radio resource control (RRC) message;
a first RRC message carrying a specific request;
a first SL RRC message;
a first SL RRC message carrying a specific request.

Here, in an embodiment of this disclosure, the above-mentioned specific bearer may specifically include at least one of the following:
signaling radio bearer (SRB) 0;
SRB1;
SRB2.

The above-mentioned specific logical channel may be any kind of logical channel or any several logical channels, and the specific logical channel may be predetermined based on a protocol.

The above-mentioned first RRC message may include at least one of the following:
RRC establishment request message;
RRC resume request message;
RRC reestablishment request message;
system information request message (e.g., the DedicatedSIBRequest message).

The above-mentioned first SL RRC message may be a remote UE information message (e.g., the RemoteUJEInformationSidelink message).

Furthermore, the above-mentioned specific request may specifically be a request for requesting specific system information. The specific system information may be any one or several types of system information, and the specific system information may be specified by a protocol. For example, the specific system information may be emergency notification system information (i.e., SIB7/8/9) and/or positioning system information. In addition, for example, when the first RRC message is the above-mentioned system information request message, the first RRC message may carry a specific request.

In step 202, the remote UE enters the active state to monitor SL between the remote UE and the relay UE.

Here, in an embodiment of this disclosure, when the remote UE enters the active state, it can monitor the SL between the remote UE and the relay UE, so that when the relay UE sends data and/or message(s) to the SL, the remote UE can successfully receive the data and/or message(s) sent by the relay UE.

In step 203, in response to receiving a second message, the remote UE stops (or called “exits”) the active state, where the second message is a response message to the first message.

In an embodiment of this disclosure, the second message may be sent by the relay UE to the remote UE.

Moreover, the second message may include at least one of the following:
a message in a specific bearer;
a message in a specific logical channel;
a second RRC message;
a second RRC message carrying a specific configuration;
a second SL RRC message;
a second SL RRC message carrying a specific configuration.

Here, the above-mentioned specific bearer may specifically include at least one of the following:
SRB0;
SRB1;
SRB2.

The above-mentioned specific logical channel may be any kind of logical channel or any several logical channels, and the specific logical channel may be predetermined based on a protocol.

Furthermore, the above-mentioned second RRC message is a response message to the above-mentioned first RRC message, where the second RRC message may include at least one of the following:
RRC establishment message:
RRC resume message;
RRC reestablishment message:
RRC reconfiguration message (RRCReconfiguration).

The above-mentioned second SL RRC message may be a response message to the above-mentioned first SL RRC message, where the second SL RRC message may be a Uu message transfer message (e.g., the UuMessage TransferSidelink message).

In addition, the above-mentioned specific configuration may include specific system information. The specific system information may be any one or several types of system information, and the specific system information may be specified by a protocol. For example, the specific system information may be emergency notification system information (i.e., SIB7/8/9) and/or positioning system information. For example, when the second RRC message is the above-mentioned RRC reconfiguration message, the second RRC message may carry a specific configuration.

Furthermore, in an embodiment of this disclosure, when the remote UE stops the active state, the remote UE stops monitoring the SL between the remote UE and the relay UE, thereby saving power consumption.

To sum up, in the message transmission method according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

FIG. 3 is a schematic flowchart of a message transmission method according to an embodiment of this disclosure. The method is performed by a remote UE. As shown in FIG. 3, the message transmission method may include the following steps.
In step 301, a first message is sent to a relay UE.
In step 302, after sending the first message to the relay UE, the remote UE immediately enters the active state.
In step 303, in response to receiving a second message, the remote UE stops the active state, where the second message is a response message to the first message.

For detailed introduction to steps 301-303, the description of forgoing embodiments can be referred to and thus will not be repeated here.

To sum up, in the message transmission method according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

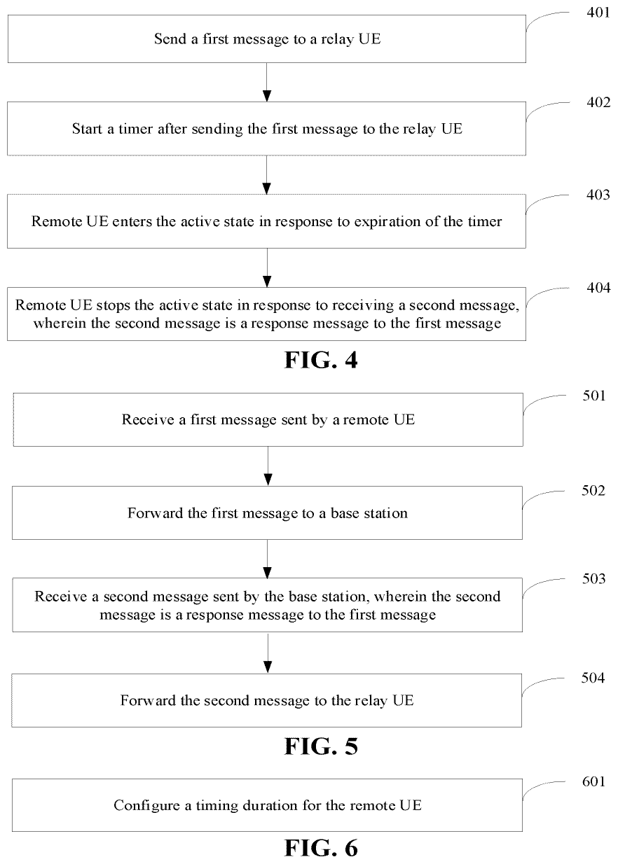

FIG. 4 is a schematic flowchart of a message transmission method according to an embodiment of this disclosure. The method is performed by a remote UE. As shown in FIG. 4, the message transmission method may include the following steps.
In step 401, a first message is sent to a relay UE.
In step 402, after the first message is sent to the relay UE, a timer is started.
In step 403, in response to expiration of the timer, the remote UE enters the active state.

In an embodiment of this disclosure, after entering the active state, the remote UE will monitor the SL so as to successfully receive the message responding to the first message subsequently sent by the relay UE.

Moreover, it should be noted that after the remote UE sends the first message, the first message is to be transmitted to the relay UE first, so that the relay UE forwards the first message to the base station. The base station parses the first message and, after generating a response message for the first message, sends the response message to the relay UE so as to be forwarded to the remote UE. It can be seen that after the remote UE sends the first message, it will not receive the response message to the first message immediately, but will wait for a period of time before it can receive the response message to the first message. Based on this, in an embodiment of this disclosure, after the remote UE sends the first message, it does not need to enter the active state immediately. Instead, it first sets a period of time based on a timer. When the timer expires, the remote UE delays entering the active state, thereby shortening the time the remote UE is in the active state and saving power. Moreover, in an embodiment of this disclosure, a timing duration of the timer satisfies the following conditions: the timing duration is less than or equal to the round trip time (RTT) of the first message. Therefore, the remote UE delays entering the active state when the timer expires, the response message will not be missed, thereby ensuring that the response message of the first message sent by the relay UE can be successfully received.

Optionally, a retention time of the active state is further determined based on any one of:
running time of T300 timer;
running time of T301 timer;
running time of T319 timer;
running time of T319a timer.

Further, in an embodiment of this disclosure, the timing duration of the timer may be configured by the network device to the remote UE. In another embodiment of the disclosure, the timing duration of the timer may also be configured by the relay UE to the remote UE. Here, when the timing duration of the timer is configured by the network device, it can be configured through an RRC message; when the timing duration of the timer is configured by the relay UE, it can be configured through a sidelink RRC message.

In step 404, in response to receiving a second message, the remote UE stops the active state, where the second message is a response message to the first message.

For other detailed introduction to steps 401-404, the description of forgoing embodiments can be referred to and thus will not be repeated here.

To sum up, in the message transmission method according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

FIG. 5 is a schematic flowchart of a message transmission method according to an embodiment of this disclosure. The method is performed by a relay UE. As shown in FIG. 5, the message transmission method may include the following steps.
In step 501, a first message sent by a remote UE is received.
In step 502, the first message is forwarded to a base station.
In step 503, a second message sent by the base station is received, where the second message is a response message to the first message.
In step 504, the second message is forwarded to the remote UE.

For detailed introduction to steps 501-504, the description of forgoing embodiments can be referred to.

To sum up, in the message transmission method according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

FIG. 6 is a schematic flowchart of a message transmission method according to an embodiment of this disclosure. The method is performed by a relay UE. As shown in FIG. 6, the message transmission method may include the following steps.
In step 601, a timing duration of a timer is configured for a remote UE.

For detailed introduction to step 601, the description of forgoing embodiments can be referred to.

To sum up, in the message transmission method according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

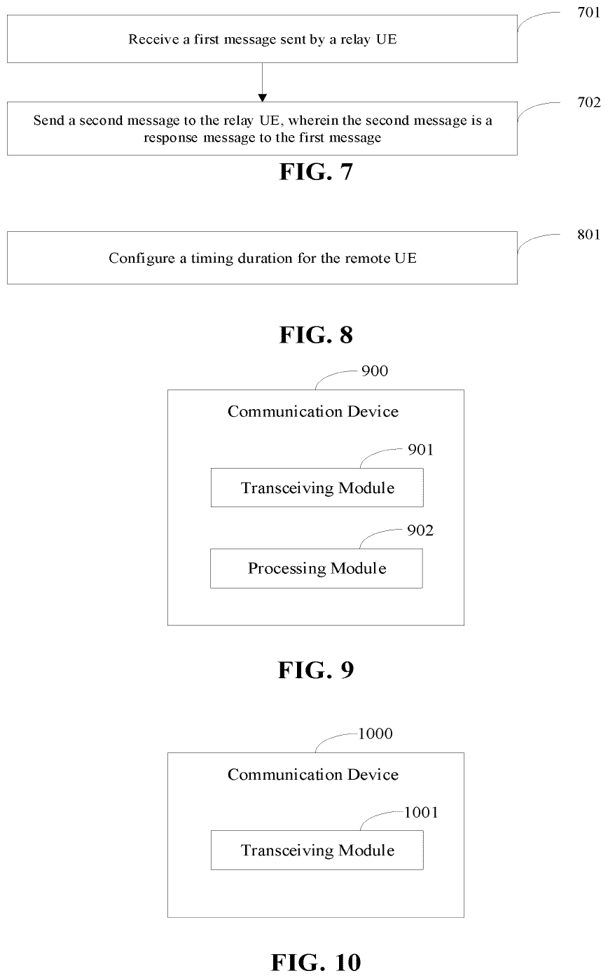

FIG. 7 is a schematic flowchart of a message transmission method according to an embodiment of this disclosure. The method is performed by a base station. As shown in FIG. 7, the message transmission method may include the following steps.
In step 701, a first message sent by a relay UE is received.
In step 702, a second message is sent to the relay UE, where the second message is a response message to the first message.

For detailed introduction to steps 701-702, the description of forgoing embodiments can be referred to.

To sum up, in the message transmission method according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

FIG. 8 is a schematic flowchart of a message transmission method according to an embodiment of this disclosure. The method is performed by a base station. As shown in FIG. 8, the message transmission method may include the following steps.
In step 801, a timing duration of a timer is configured for a remote UE.

For detailed introduction to step 801, the description of forgoing embodiments can be referred to.

To sum up, in the message transmission method according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

FIG. 9 is a schematic structural diagram of a communication device according to an embodiment of this disclosure. As shown in FIG. 9, the device may include:
a transceiving module 901, configured to send a first message to a relay UE; and
a processing module 902, configured to monitor, in an active state of the remote UE, an SL between the remote UE and the relay UE.

The processing module 902 is further configured to stop the active state of the remote UE in response to receiving a second message, where the second message is a response message to the first message.

To sum up, in the communication device according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

Optionally, in an embodiment of this disclosure, the processing module is further configured to:
cause the remote UE to enter the active state immediately after sending the first message to the relay UE.

Optionally, in an embodiment of this disclosure, the processing module is further configured to:
start a timer after sending the first message to the relay UE; and
cause the remote UE to enter the active state in response to expiration of the timer.

Optionally, in an embodiment of this disclosure, the device is further configured to:
receive a timing duration configured by a network device for the timer;
receive a timing duration configured by the relay UE for the timer.

Optionally, in an embodiment of this disclosure, a retention time of the UE active state is further determined based on any one of the following:
a running time of T300 timer;
a running time of T301 timer;
a running time of T319 timer;
a running time of T319a timer.

Optionally, in an embodiment of this disclosure, the first message includes at least one of the following:
a message in a specific bearer;
a message in a specific logical channel;
a first RRC message;
a first RRC message carrying a specific request;
a first SL RRC message;
a first SL RRC message carrying a specific request.

Optionally, in an embodiment of this disclosure, the second message includes at least one of the following:
a message in a specific bearer;
a message in a specific logical channel;
a second RRC message;
a second RRC message carrying a specific configuration;
a second SL RRC message;
a second SL RRC message carrying a specific configuration.

Optionally, in an embodiment of this disclosure, the specific bearer includes at least one of the following:
SRB0;
SRB1;
SRB2.

Optionally, in an embodiment of this disclosure, the first RRC message includes at least one of:
an RRC establishment request message;
an RRC resume request message;
an RRC reestablishment request message;
a system information request message.

Optionally, in an embodiment of this disclosure, the first SL RRC message includes a remote UE information message, RemoteUEInformationSidelink.

Optionally, in an embodiment of this disclosure, the specific request includes a request for specific system information.

Optionally, in an embodiment of this disclosure, the second RRC message includes at least one of the following:
an RRC establishment message;
an RRC resume message;
an RRC reestablishment message;
an RRC reconfiguration message.

Optionally, in an embodiment of this disclosure, the second SL RRC message includes a Un message transfer message, UuMessageTransferSidelink.

Optionally, in an embodiment of this disclosure, the specific configuration includes specific system information.

Optionally, in an embodiment of this disclosure, the specific system information is specified by a protocol.

FIG. 10 is a schematic structural diagram of a communication device according to an embodiment of this disclosure. As shown in FIG. 10, the device may include:
a transceiving module 1001, configured to receive a first message sent by a remote UE.

The transceiving module is further configured to forward the first message to a base station.

The transceiving module is further configured to receive a second message sent by the base station, where the second message is a response message to the first message.

The transceiving module is further configured to forward the second message to the relay UE.

To sum up, in the communication device according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UB, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

Optionally, in an embodiment of this disclosure, the device is configured to:
configure a timing duration of a timer for the remote UE.

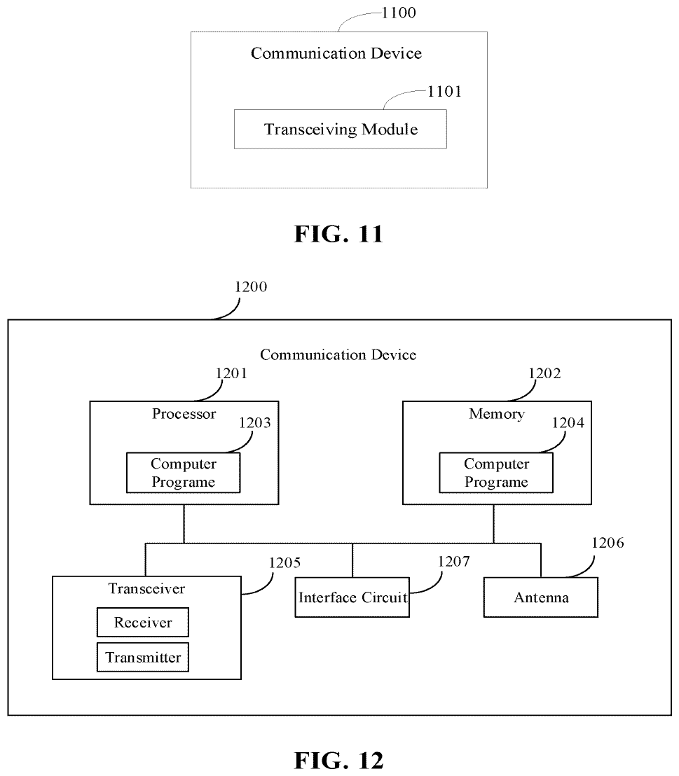

FIG. 11 is a schematic structural diagram of a communication device according to an embodiment of this disclosure. As shown in FIG. 11, the device may include:
a transceiving module 1101, configured to receive a first message sent by a relay UE.

The transceiving module is further configured to send a second message to the relay UE, wherein the second message is a response message to the first message.

To sum up, in the communication device according to some embodiments of this disclosure, after sending the first message to the relay UE, the remote UE will enter the active state. Subsequently, after receiving the second message sent by the relay UE, the active state will be stopped, where the second message is a response message to the first message. It can be seen that in some embodiments of this disclosure, the active state will be stopped only after the remote UE receives the response message (i.e., the second message) of the relay UE to the first message sent by the remote UE, thereby avoiding the occurrence of “after sending the first message to the relay UE, the remote UE enters the SL DRX sleep state, resulting in the remote UE being unable to receive the response message sent by the relay UE”, and ensuring successful receiving of the response message (i.e., the second message) by the remote UE, so that the connection establishment/connection resume/connection reestablishment procedure(s) can be successfully implemented, the delay in sending system information can be avoided, and the stability of SL communication can be ensured.

Optionally, in an embodiment of this disclosure, the device is configured to:
configure a timing duration of a timer for the remote UE.

Referring to FIG. 12, which is a schematic structural diagram of a communication device 1200 according to an embodiment of the present application. The communication device 1200 may be a network device; or a terminal device; or a chip, a chip system, or a processor that supports a network device to implement the above methods; or a chip, a chip system, or a processor that supports a terminal device to implement the above methods. The device can be configured to implement the methods described in the above method embodiments, for details of which the description in the above method embodiments can be referred to.

The communication device 1200 may include one or more processors 1201. The processor 1201 may be a general-purpose processor or a special-purpose processor, or the like. For example, it can be a baseband processor or a central processing unit (CPU). The baseband processor can be used to process communication protocols and communication data. The CPU can be used to control communication devices (e.g., base stations, baseband chips, terminal device, terminal device chips, DU or CU, etc.), execute computer programs, and process data for computer programs.

Optionally, the communication device 1200 may also include one or more memories 1202, on which a computer program 1204 may be stored. The processor 1201 executes the computer program 1204, so that the communication device 1200 performs the steps described in the above method embodiments. Optionally, the memory 1202 may also store data. The communication device 1200 and the memory 1202 can be provided separately or integrated together.

Optionally, the communication device 1200 may also include a transceiver 1205 and an antenna 1206. The transceiver 1205 may be called a transceiver unit, a transceiver, a transceiver circuit, or the like, and is used to implement transceiver functions. The transceiver 1205 may include a receiver and a transmitter. The receiver may be called a receiver, a receiving circuit, or the like, and is used to implement the receiving function. The transmitter may be called a transmitter, a transmitting circuit, or the like, and is used to implement the transmitting function.

Optionally, the communication device 1200 may also include one or more interface circuits 1207. The interface circuit 1207 is used to receive code instructions and transmit them to the processor 1201. The processor 1201 executes the code instructions to cause the communication device 1200 to perform the method described in the above method embodiments.

The communication device 1200 may be a remote UE, in which the transceiver 1205 is used to perform steps 201 and 203 in FIG. 2; steps 301 and 303 in FIG. 3; and steps 401 and 403 in FIG. 4. The processor 1201 is used to perform step 202 in FIG. 2; step 302 in FIG. 3; and step 402 in FIG. 4.

The communication device 1200 may be a relay UE, in which the transceiver 1205 is used to perform the steps in FIG. 5 and FIG. 6.

The communication device 1200 may be a base station, in which the transceiver 1205 is used to perform the steps in FIG. 7 and FIG. 8.

As an implementation, the processor 1201 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated. The above-mentioned transceiver circuit, interface or interface circuit can be used for reading and writing codes/data, or the above-mentioned transceiver circuit, interface or interface circuit can be used for signal transmission or transfer.

As an implementation, the processor 1201 may store a computer program 1203. and the computer program 1203 runs on the processor 1201, causing the communication device 1200 to perform the method described in the above method embodiments. The computer program 1203 may be solidified in the processor 1201, in which case the processor 1201 may be implemented by hardware.

As an implementation, the communication device 1200 may include a circuit, which may implement the functions of sending or receiving or communicating in the foregoing method embodiments. The processor and transceiver described in this application can be implemented in integrated circuits (ICs), analog ICs, radio frequency integrated circuits (RFICs), mixed signal ICs, application specific integrated circuits (ASICs), printed circuit boards (PCBs), electronic devices, and the like. The processor and transceiver can also be manufactured using various IC process technologies, such as complementary metal oxide semiconductor (CMOS), n-type metal oxide-semiconductor (NMOS), p-type metal oxide semiconductor (PMOS), bipolar junction transistor (BJT), bipolar CMOS (BiCMOS), silicon germanium (SiGe), gallium arsenide (GaAs), and the like.

The communication device described in the above embodiments may be a network device or a terminal device, but the scope of the communication device described in this application is not limited thereto, and the structure of the communication device may not be limited by FIG. 12. The communication device may be a stand-alone device or may be part of a larger device. For example, the communication device may be:
(1) an independent IC, a chip, a chip system, or a subsystem;
(2) a collection of one or more ICs: optionally, the IC collection may further include storage components for storing data and computer programs;
(3) ASIC, such as modem;
(4) a module that can be embedded in other devices;
(5) a receiver, a terminal device, an intelligent terminal device, a cellular phone, a wireless device, a handheld device, a mobile unit, a vehicle-mounted device, a network device, a cloud device. an artificial intelligence device, or the like; and
(6) others.

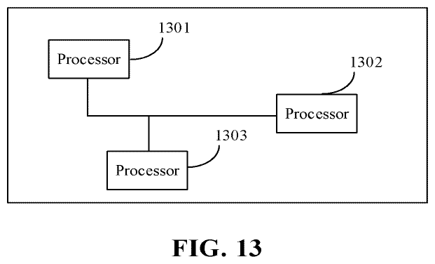

For the case where the communication device may be a chip or a chip system, a schematic structural diagram of the chip shown in FIG. 13 can be referred to. The chip shown in FIG. 13 includes a processor 1301 and an interface 1302. The number of processors 1301 may be one or more, and the number of interfaces 1302 may be multiple.

Optionally, the chip also includes a memory 1303, which is configured to store necessary computer programs and data.

Those skilled in the art can also understand that the various illustrative logical blocks and steps listed in the embodiments of this application can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the protection scope of the embodiments of the present application.

This application further provides a readable storage medium on which instructions are stored. When the instructions are performed by a computer, the functions of any of the above method embodiments are implemented.

This application further provides a computer program product, which, when performed by a computer, implements the functions of any of the above method embodiments.

In the above embodiments, it may be implemented in whole or in part by software, hardware, firmware, or any combination thereof. When implemented using software, it may be implemented in whole or in part in the form of a computer program product. The computer program product includes one or more computer programs. When the computer program is loaded and performed on a computer, the processes or functions described in the embodiments of the present application are generated in whole or in part. The computer may be a general-purpose computer, a special-purpose computer, a computer network, or other programmable device. The computer program may be stored in or transferred from one computer-readable storage medium to another, for example, the computer program may be transferred from a website, computer, server, or data center to another website, computer, server or data center through wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server, data center, etc. that contains one or more available medium integrated. The usable medium may be magnetic medium (e.g., floppy disks, bard disks, magnetic tapes), optical medium (e.g., high-density digital video discs (DVD)), semiconductor medium (e.g., solid state disks (SSD)), or the like.

Those of ordinary skill in the art can understand that the first, second, and other numerical numbers involved in this application are only for convenience of description and are not intended to limit the scope of the embodiments of this application, but may also indicate the order.

“At least one” in this application can also be described as one or more, and “a plurality of” can be two, three, four or more, which is not limited by this application. In the embodiments of this application, for a technical feature, the technical feature is distinguished by “first”, “second”, “third”, “A”, “B”, “C” and “D”, etc. The technical features described in “first”, “second”, “third”, “A”, “B”, “C” and “D” are in no particular order or sequence.

The corresponding relationships shown in each table in this application can be configured or predefined. The values of the information in each table are only examples and can be configured as other values, which are not limited by this application. When configuring the correspondence between information and each parameter, it is not necessarily required to configure all the correspondences shown in each table. For example, in the table in this application, the corresponding relationships shown in some rows may not be configured. For another example, appropriate deformation adjustments can be made based on the above table, such as splitting, merging, etc. The names of the parameters shown in the titles of the above tables may also be other names understandable by the communication device, and the values or expressions of the parameters may also be other values or expressions understandable by the communication device. When implementing the above tables, other data structures can also be used, such as arrays, queues, containers, stacks, linear lists, pointers, linked lists, trees, graphs, structures, classes, heaps, hash, bash tables, or the like.

Predefinition in this application can be understood as definition, pre-definition, storage, pre-storage, pre-negotiation, pre-configuration, solidification, or pre-burning.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Those of ordinary skill in the art may implement the described functionality using different methods for each specific application, but such implementations should not be considered beyond the scope of this application.

Those of ordinary skill in the art can clearly understand that for the convenience and simplicity of description, the specific working processes of the systems, devices and modules described above can be understood by referring to the corresponding processes in the foregoing method embodiments, which will not be repeated here.

The above are only specific embodiments of the present application, but the protection scope of the present application is not limited thereto. Those of ordinary skill in the art can easily think of changes or substitutions within the technical scope disclosed in the present application, which should be covered by the protection scope of this application. Therefore, the protection scope of this application should be subject to the protection scope of the claim.

1. A message transmission method, comprising:
sending, by a remote user equipment (UE), a first message to a relay UE;
entering an active state to monitor a sidelink (SL) between the remote UE and the relay UE; and
exiting the active state, wherein the remote UE receives a second message, and the second message is a response message to the first message.

2. The method of claim 1, wherein entering the active state comprises:
entering the active state immediately after sending the first message.

3. The method of claim 1, wherein entering the active state comprises:
starting a timer after sending the first message to the relay UE; and
entering the active state in response to expiration of the timer.

4. The method of claim 3, further comprising at least one of:
receiving a timing duration configured by a network device for the timer; or
receiving a timing duration configured by the relay UE for the timer.

5. The method of claim 1, wherein a retention time of the UE active state is further determined based on any one of:
a running time of T300 timer;
a running time of T301 timer;
a running time of T319 timer; or
a running time of T319a timer.

6. The method of claim 1, wherein the first message comprises at least one of:
a message in a specific bearer;
a message in a specific logical channel;
a first radio resource control (RRC) message;
a first RRC message carrying a specific request;
a first SL RRC message; or
a first SL RRC message carrying a specific request.

7. The method of claim 1, wherein the second message comprises at least one of:
a message in a specific bearer;
a message in a specific logical channel;
a second RRC message;
a second RRC message carrying a specific configuration;
a second SL RRC message; or
a second SL RRC message carrying a specific configuration.

8. The method of claim 6, wherein the specific bearer comprises at least one of:
signaling radio bearer (SRB) 0;
SRB1; or
SRB2.

9. The method of claim 6, wherein the first RRC message comprises at least one of:
an RRC establishment request message;
an RRC resume request message;
an RRC reestablishment request message; or
a system information request message.

10. The method of claim 6, wherein the first SL RRC message comprises a remote UE information message (RemoteUEInformationSidelink).

11. The method of claim 6, wherein the specific request comprises a request for specific system information.

12. The method of claim 7, wherein the second RRC message comprises at least one of:
an RRC establishment message;
an RRC resume message;
an RRC reestablishment message; or
an RRC reconfiguration message.

13. The method of claim 7, wherein the second SL RRC message comprises a Uu message transfer message (UuMessageTransferSidelink).

14. The method of claim 7, wherein the specific configuration comprises specific system information.

15. The method of claim 11, wherein the specific system information is specified by a protocol.

16. A message transmission method, comprising:
receiving, by a relay user equipment (UE), a first message sent by a remote UE;
forwarding, by the relay UE, the first message to a base station;
receiving, by the relay UE, a second message sent by the base station, wherein the second message is a response message to the first message; and
forwarding, by the relay UE, the second message to the relay UE.

17. The method of claim 15, further comprising:
configuring a timing duration for the remote UE.

18-25. (canceled)

26. A remote user equipment (UE), comprising a processor and a memory, wherein a computer program is stored in the memory, and the processor is configured to execute the computer program stored in the memory, thereby causing the remote UE to implement a message transmission method comprising:
sending a first message to a relay UE;
entering an active state to monitor a sidelink (SL) between the remote UE and the relay UE; and
exiting the active state, wherein the remote UE receives a second message, and the second message is a response message to the first message.

27. A relay user equipment (UE), comprising a processor and a memory, wherein a computer program is stored in the memory, and the processor is configured to execute the computer program stored in the memory, thereby causing the remote UE to implement a message transmission method according to claim 16.

28. A non-transitory computer readable storage medium for storing instructions therein, wherein the instructions, upon being executed, cause a processor of a remote user equipment (UE) to implement a message transmission method according to claim 1.
